(19) United States
(12) Patent Application Publication
(10) Pub. No.: US 2018/0294701 A1
(43) Pub. Date: Oct. 11, 2018

(54) WAVE WINDING APPARATUS

(71) Applicant: Aumann Espelkamp GmbH, Espelkamp (DE)

(72) Inventor: Wolfgang Lüttge, Hameln (DE)

(73) Assignee: Aumann Espelkamp GmbH, Espelkamp (DE)

(21) Appl. No.: 15/753,759

(22) PCT Filed: Dec. 15, 2016
(86) PCT No.: PCT/EP2016/081108

§ 371 Date: Feb. 20, 2018

(30) Foreign Application Priority Data
Dec. 18, 2015 (EP) 15201100.3

(51) Int. Cl. H02K 15/04; B65G 15/56

(52) U.S. Cl. CPC H02K 15/0478; B65G 2201/0232; B65G 15/56

(57) ABSTRACT

A wave winding device for manufacturing wave windings has a winding unit with a winding blade device rotatable about a winding axis in a winding direction and on which a winding wire is to be wound. The wave winding device has at least one wire feed device that supplies the winding wire to the winding unit in a feed direction to wind the winding blade device, and also has a transport device for transporting the winding wire, which is wound onto the winding blade device to form a wave winding, in a transport direction parallel to the winding axis. The transport device has a conveyor system that moves the wave winding through the transport device in the transport direction. The conveyor system is supported in the transport device so as to be rotatable about a rotational axis in the winding direction, coaxially with respect to the winding axis.

### STATEMENT OF RELATED APPLICATIONS

The application is the US PCT National Phase of International Application No. PCT/EP2016/081108 having an International Filing Date of 15 Dec. 2016, which claims priority on European Patent Application No. 15201100.3 having a filing date of 18 Dec. 2015.

### BACKGROUND OF THE INVENTION

### Technical Field

The invention relates to a wave winding device for manufacturing wave windings.

### Prior Art

Wave windings are used, among other things, for manufacturing stators for electric motors. The winding wire, which may be a round wire or also a flat wire, is generally supplied via a feed device and wound onto a winding blade. In the process, waves must be created. This takes place in that during the winding around the blade, the winding operation must be interrupted and the wire deflected transversely with respect to the feed direction in order to obtain the characteristic wave pattern. Depending on the desired wiring on the stator, in such wave windings it is customary for a plurality of wires, for example six wires, to be simultaneously supplied and wound.

In previous winding devices, a winding blade is used that corresponds to the length of the winding mat to be produced. Adaptation, or driving different (specifically, longer) lengths of winding mats, if possible at all, requires significant effort. In addition, known devices require a relatively large amount of installation space, since the winding mats may be several meters long.

### BRIEF SUMMARY OF THE INVENTION

The object of the present invention is to provide a wave winding device with which manufacture of wave winding mats of virtually any length, with a comparatively small installation space, is possible.

This object is achieved by a wave winding device for manufacturing wave windings, having a winding unit with a winding blade device which is rotatable about a winding axis in a winding direction and on which a winding wire is to be wound, and having at least one wire feed device that supplies the winding wire to the winding unit in a feed direction in order to wind the winding blade device, and having a transport device that is designed for transporting the winding wire, which is wound onto the winding blade device to form a wave winding, in a transport direction parallel to the winding axis, wherein the transport device has a conveyor system that moves the wave winding through the transport device in the transport direction, wherein the conveyor system is supported in the transport device so as to be rotatable about a rotational axis in the winding direction, coaxially with respect to the winding axis; advantageous embodiments are set forth in the dependent claims.

The wave winding device according to the invention has a winding unit with a winding blade device that is rotatable about a winding axis in a winding direction. A winding wire that is supplied by a wire feed device may be wound onto this winding blade device. The wire feed device is likewise encompassed by the device according to the invention, and supplies the winding wire to the winding unit in a feed direction in order to wind the winding blade device. In addition, the device according to the invention has a transport device. The transport device is designed for transporting the winding wire, which is wound onto the winding blade device to form a wave winding, in a transport direction parallel to the winding axis. For this purpose, the transport device has a conveyor system that moves the wave winding through the transport device in the transport direction. The conveyor system itself is supported in the transport device so as to be rotatable about a rotational axis in the winding direction, coaxially with respect to the winding axis.

Due to the transport device that rotates along with the winding blade, the winding blade itself may have a very short, and thus also more stable, design. During production of the wave windings, the resulting winding mat may be further transported in the transport direction in any rotational position of the winding blade device, so that in principle, the manufacture of winding mats having any given length is possible with only a very short winding blade. The device according to the invention thus saves installation space, and is very flexible with regard to the length of the winding mats to be produced. In addition, the mat does not have to be laboriously removed from a long winding blade; instead, according to the invention the mat is already pushed off from the blade during the manufacturing process for the winding mat.

The device according to the invention preferably has a control unit that synchronizes the rotation of the winding blade device and of the conveyor system in such a way that both rotate about the same rotational axis, essentially at the same speed in the winding direction. In this way, the winding process may be continued for any desired period of time without resulting in torsion in the produced winding mat. Assistance is provided by the synchronization of the winding blade rotation on the one hand, and the conveyor system on the other hand.

According to one advantageous embodiment of the device according to the invention, it is provided that the device has at least one retaining means that is designed for holding a section of the winding wire while another section of the winding wire is moved relative thereto. This may be achieved in different ways. For example, the retaining means may be part of the winding blade system or may be a separate gripping device, or may also be designed as part of the transport device. It is important that the retaining means, alone or in cooperation with the winding blade, may hold at least sections of the winding wire, so that these sections may be moved in parallel to the transport direction, either by the retaining means itself or by some other translation device, so that the characteristic waves may result.

At least one gripping or clamping element that is situated on the winding unit is preferably provided as the retaining means. The gripping or clamping element may be supported so as to be displaceable on the winding unit, in or against the transport direction.

In addition, it may be provided that the gripping or clamping element has clamping jaws with which the winding wire may be fixed between the clamping jaws and the winding blade device.

In order to simultaneously process a plurality of winding wires—which may generally, but do not have to, be flat wires in all embodiments of the invention—to form a wave winding mat, it may be provided in particular that the retaining means is designed for simultaneously holding a plurality of winding wires supplied in parallel to one another. It is advantageous when the retaining means has at least one separation groove for accommodating only one winding wire. In this way, the individual winding wires may be laid down separately on the winding blade in a defined position relative to one another, and wound at that location to form a wave winding. It is preferred that for each retaining means, at least as many separation grooves are provided as the number of winding wires that are supplied to this retaining means.

In order to keep the winding heads of the resulting wave winding as flat as possible, in particular for windings made of flat wires, according to one advantageous embodiment the device according to the invention has a pressing unit. The pressing unit is preferably situated adjacent to the winding blade device, and is designed for compressing the winding heads of the wave winding.

### BRIEF DESCRIPTION OF THE DRAWING

FIG. 1 is a perspective view of an exemplary embodiment of the apparatus of the present invention.

### DETAILED DESCRIPTION OF PREFERRED EMBODIMENTS

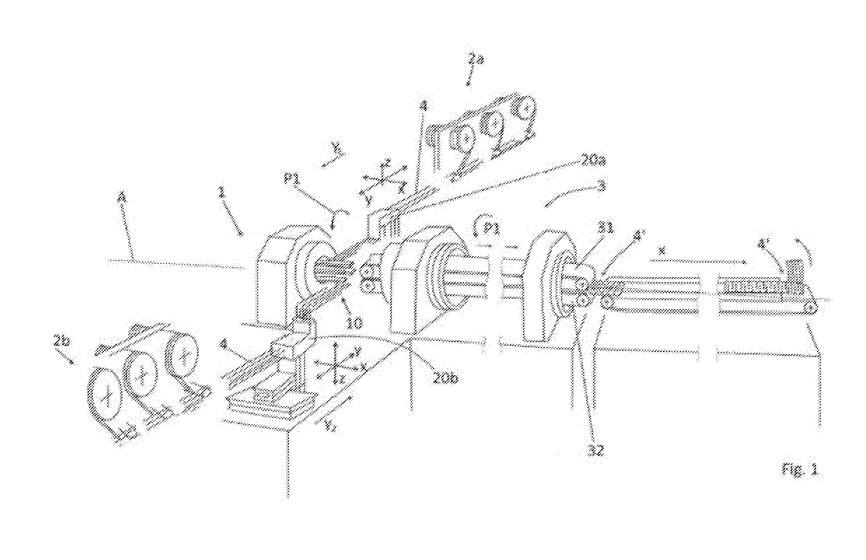

The invention is explained in greater detail below with reference to the exemplary embodiment shown in FIG. 1.

The illustrated wave winding device has at least one feed device 2a, 2b (two feed devices are shown here; the invention expressly also encompasses wave winding devices having only one feed device or having three or more feed devices).

The feed devices 2a, 2b guide one or a plurality of winding wires 4 in a corresponding feed direction y1, y2 to a (shared) winding unit 1. The winding unit 1 has a winding blade device 10 that includes at least one winding blade which protrudes from the winding unit 1, transversely with respect to the feed direction y1, y2 (perpendicular to the Y axis), and around which the supplied wire 4 is wound. For this purpose, the winding blade device 10 has a rotational axis A about which the winding blade is rotatably supported in a rotational direction P1. The winding takes place in such a way that the at least one wire 4 is fixed, in particular pressed against the winding blade device 10, via retaining means such as grippers or clamping jaws (not illustrated in greater detail), and the winding blade device 10 undergoes a half rotation by 180° about the axis A. After each half rotation, the winding wire 4 is held via the retaining means and bent to form the characteristic wave. This may take place, for example, by translationally moving the wire nozzle unit 20a or 20b, which supplies the wire 4, in a direction Y transverse to the feed direction. The operation is repeated after another half rotation of the blade, which gradually results in a winding mat 4′ having wave windings.

The resulting winding mat 4′ is successively further transported away from the winding unit 1 and the winding blade device 10 in a transport direction X via a transport device 3, so that the winding blade may be short in the transport direction X and the installation space may have a space-saving design. The transport device 3 has a conveyor system which is designed here as a belt conveyor or toothed-belt conveyor or also a chain conveyor 31, 32, and which ensures that the winding mat 4′ is transported away from the winding unit 1 in the transport direction X (in the present case, perpendicular to the vertical direction Z and perpendicular to the feed direction Y, y1, y2). The conveyor system 31, 32, the same as the winding blade 10, is supported on the transport device 3 so as to be rotatable about the machine axis A in the direction P1. In this way, the transport device 3 may accept the wave winding mat that results on the winding blade, while further waves are being created by rotating the blade and bending the wire 4. Complete windings are transported away in the direction X due to the corotation of the conveyor system 31, 32. In this way, winding mats 4′ having virtually any given length are producible.

For additional machining of the winding heads of the wave windings, which result in each case by folding over the winding wire by 180° during each half rotation of the winding blade, a pressing unit which presses the winding heads flat may be provided between the conveyor system 31, 32 and the winding unit 1.

1. A wave winding device for manufacturing wave windings, comprising:
a winding unit with a winding blade device which is rotatable about a winding axis in a winding direction and on which a winding wire is to be wound;
at least one wire feed device that supplies the winding wire to the winding unit in a feed direction in order to wind the winding blade device; and
a transport device that is designed for transporting the winding wire, which is wound onto the winding blade device to form a wave winding, in a transport direction parallel to the winding axis,
wherein the transport device has a conveyor system that moves the wave winding through the transport device in the transport direction (X), and
wherein the conveyor system is supported in the transport device so as to be rotatable about a rotational axis in the winding direction, coaxially with respect to the winding axis.

2. The wave winding device according to claim 1, further comprising
a control unit that synchronizes the rotation of the winding blade device and of the conveyor system in such a way that both rotate about the same rotational axis, essentially at the same speed in the winding direction.

3. The wave winding device according to claim 1, further comprising
at least one retaining means that is designed for holding a section of the winding wire while another section of the winding wire is moved relative thereto.

4. The wave winding device according to claim 3, further comprising
at least one gripping or clamping element situated on the winding unit or on the transport device, the at least one gripping or clamping element being provided as the at least one retaining means.

5. The wave winding device according to claim 4, wherein
the gripping or clamping element is supported on the winding unit so as to be displaceable in the transport direction.

6. The wave winding device according to claim 4, wherein
the gripping or clamping element has clamping jaws with which the winding wire may be fixed between the clamping jaws and the winding blade device.

7. The wave winding device according to claim 3, wherein
the at least one retaining means is designed for simultaneously holding a plurality of winding wires supplied in parallel to one another.

8. The wave winding device according to claim 3, wherein
the at least one retaining means has at least one separation groove for accommodating only one winding wire.

9. The wave winding device according to claim 1, further comprising
a pressing unit that is situated adjacent to the winding blade device, the pressing unit being designed for compressing the winding heads of the wave winding.

10. The wave winding device according to claim 2, further comprising at least one retaining means that is designed for holding a section of the winding wire while another section of the winding wire is moved relative thereto.

11. The wave winding device according to claim 10, further comprising at least one gripping or clamping element situated on the winding unit or on the transport device, the at least one gripping or clamping element being provided as the at least one retaining means.

12. The wave winding device according to claim 11, wherein the gripping or clamping element is supported on the winding unit so as to be displaceable in the transport direction.

13. The wave winding device according to one of claim 11, wherein the gripping or clamping element has clamping jaws with which the winding wire may be fixed between the clamping jaws and the winding blade device.

14. The wave winding device according to one of claim 10, wherein the at least one retaining means is designed for simultaneously holding a plurality of winding wires supplied in parallel to one another.

15. The wave winding device according to one of claim 10, wherein the at least one retaining means has at least one separation groove for accommodating only one winding wire.

16. The wave winding device according to claim 10, further comprising a pressing unit that is situated adjacent to the winding blade device, the pressing unit being designed for compressing the winding heads of the wave winding.
